(19) United States
(12) Patent Application Publication
(10) Pub. No.: US 2015/0221998 A1
(43) Pub. Date: Aug. 6, 2015

(54) Energy Storage System Preventing Self from Overheating and Method for Preventing Energy Storage System from Overheating

(71) Applicants: Hong Jin, Beijing (CN); George H. Brilmyer, Johnson City, TN (US); Michael T. Nispel, Malvern, PA (US); Dongxue Ren, Beijing (CN); Dajun BAI, Beijing (CN)

(72) Inventors: Hong Jin, Beijing (CN); George H. Brilmyer, Johnson City, TN (US); Michael T. Nispel, Malvern, PA (US); Dongxue Ren, Beijing (CN); Dajun BAI, Beijing (CN)

(73) Assignee: National Institute of Clean-And-Low-Carbon Energy, Changping District, Beijing (CN)

(21) Appl. No.: 14/395,380

(22) PCT Filed: Apr. 20, 2012
(86) PCT No.: PCT/CN2012/074436

§ 371 Date: Mar. 30, 2015

(51) Int. Cl. H01M 10/6551; H01M 2/10

(52) U.S. Cl. CPC H01M 10/6551; H01M 2/1077

(57) ABSTRACT

The present invention provides an energy storage system, particularly a battery system, that is capable of preventing self from overheating, comprising at least one energy storage unit each having two terminal posts extending outwards from the interior thereof; when there are at least two energy storage units, electrical connection therebetween is achieved by electrical connection elements that bridge the terminal posts of different energy storage units; at least one of the terminal posts and/or the electrical connection elements is in thermal connection with a heat transfer surface enlarging structure made of solid heat conductive materials. The present invention further relates to a method for preventing overheat of an energy storage system.

### TECHNICAL FIELD

The present invention relates to an energy storage system, particularly to a battery system, and more particularly to a valve-regulated type lead-acid battery system, that is capable of preventing self from overheating. The present invention further relates to a method for preventing overheat of the energy storage system.

### BACKGROUND OF THE INVENTION

As an energy storage system, a battery and a system thereof are means for storing electric energy so as to restore the energy when needed. Typically, a cell includes two electrodes arranged in the electrolyte, i.e. an anode and a cathode. As known in related technologies, an electrical apparatus to be operated is usually connected across the cathode and anode at two ends to obtain electrical energy from the cell.

Invented in 1859, the lead acid battery has more than 150 years of history. It still remains to be one of the most popular batteries nowadays and has been widely used in technical fields such as electricity, communication, railway, petroleum, aviation, irrigation, coal, geology, medical care, rail transportation, national defense facilities and so on.

A lead-acid battery as well as a system thereof is such a device that converts electrical energy into chemical energy for storage and then converts the chemical energy into electrical energy to be supplied to electrical apparatuses for use when needed. The cathode active substance in the lead-acid cell is PbO₂, and the anode active substance is sponge-like lead (Pb), and the electrolyte is liquid H₂SO₄. The process of charging and discharging the lead-acid cell is achieved by electrochemical reactions. As shown in the following reaction equation, Pb (anode) and lead oxide (cathode) react with H₂SO₄ during the discharging process of the lead-acid cell to generate lead sulfate. The charging process exhibits a reverse reaction of the discharging process.

Cathode reaction: PbO₂+4H⁺+SO₄²⁻+2e⁻ [symbol] PbSO₄+2H₂O

Anode reaction: Pb+SO4²⁻ [symbol] PbSO₄+2e⁻

Overall reaction: Pbo₂+Pb+2H₂SO₄ [symbol] 2PbSO₄+2H₂O

Currently, the lead acid battery is widely used all over the world with more than 50% of battery market share due to its reliability and low cost. Traditional lead-acid batteries are mostly used in small-scale and low-rate applications, such as those in auxiliary devices or back-up power, so the overheat and heat dissipation problems are not so noticeable, nor are there any particular solutions to these problems. However, with recent development of smart grid and the increasing amount of interest in renewable energy (e.g. wind power, solar energy and so on), the demand in large-scale energy storage system has never been more imperative. At present, lead-acid batteries have already been used in Uninterruptible Power Supplies (UPS). The emerging applications in technology pose new challenges to lead-acid batteries and other types of batteries. For example, overheating occurs in almost any large-scale applications that are usually of high rate and multi-cycle, which shortens the cycle life and sometimes even causes permanent damage to the batteries and especially to the lead acid batteries. Therefore, the thermal management technology is extremely important for the lead acid battery in large-scale applications in maintaining proper system health etc.

The conventional solution for overheating is to over-size the batteries, so that the relative discharge rate and the depth of discharge are smaller. But this, on the other hand, increases the total system cost tremendously.

The prior art lead-acid batteries are mainly classified into two types: flooded type and valve-regulated type. The heat dissipation problem is more severe in the valve-regulated type lead-acid batteries (VRLA batteries) than the flooded type lead-acid batteries because excess electrolyte in cells of the latter fills the three-dimensional space in the cells except for those occupied by the electrodes, thereby the thermal contact between internal members of the cells is enhanced. Gases are generated during charging and the gases remove heat from the cell via water loss and acid mist. In contrast, in a cell of a valve-regulated type lead-acid battery, the acid liquid is absorbed in saturation by a separator (e.g. absorptive glass fiber fabric), so there is no excess liquid electrolyte in the cell. The limited contact of the acid, separators and plates with the plastic case walls limits the heat transfer out of the cell because of the lack of a heat dissipation passage and therefore increases the operating temperature, which limits the cycle life of valve-regulated type lead-acid battery and thus their potential applications in large-scale.

Overheating of the valve-regulated type lead-acid battery, as a matter of fact, is mainly caused by heat release from chemical reactions and ohmic heat (resistance heat generated from grid plate, bus-bar, separator, terminal post and etc. of the cell due to their resistance). The chemical reaction is very intense, for example the oxygen recombination reaction during the charging process is exothermic with an enthalpy of 68.32 kcal/mol. When the temperature of the positive plate is increased, the rate of oxygen evolution increases rapidly and a bigger portion of oxygen recombines at the negative plate, giving rise of a further temperature rise there. The cell temperature can easily exceed 80° C. and the cell can go into ‘thermal runaway’ thus forcing the cell temperature even higher. In some instances thermal runaway can lead to softening or even burning of the polymer case. The ohmic heat (I²R) also comes from the inside of the cell. The shell of a cell is generally made of polymer materials, and the heat dissipation contact area is very limited through metallic components of a cell such as grid plate, bus-bar and terminal post, thus heat within the interior of the cell is not easy to be dissipated.

In high rate applications of a battery, according to Arrhenius Equation, reaction rate of any chemical reaction is generally increased to as much as two times with the increase of temperature by 10 degrees. This principle is applicable to product life approximation based on failure mode (chemical reaction, such as corrosion, oxygen recombination reaction and so on), in particular applicable to the life approximation of a lead-acid battery. According to IEEE Recommended practice for Maintenance, Testing and Replacement of Vented Lead-acid Batteries for Stationary Applications, IEEE power engineering society, IEEE std 450™-2002, 3 Apr., 2003, it is calculated that the life of a lead acid battery is shortened by 50% when the working temperature of the lead acid battery increases from 25 to 33.

In order to prevent overheating of a battery and its system and prolong life thereof, various solutions have been proposed at present for thermal control or thermal management during operation of the battery, wherein most of the solutions focus on thermal control or thermal management on a side or bottom of a cell, e.g. U.S. Pat. No. 7,967,256, U.S. Pat. No. 7,531,270, U.S. Pat. No. 6,533,031, U.S. Pat. No. 6,512,347, U.S. Pat. No. 6,407,553, U.S. Pat. No. 5,695,891, U.S. Pat. No. 5,385,793, U.S. Pat. No. 5,356,735, U.S. Pat. No. 4,913,985. These modified designs relate to built-in arrangements which are also technically challenging in maintenance and heat dissipation. As stated above, heat generated in a valve-regulated type lead-acid battery is difficult to be dissipated to the outside, so heat dissipation effect is not quite satisfactory when the prior art thermal control or thermal management method is applied to the valve-regulated type lead-acid battery.

U.S. Pat. No. 7,651,811 discloses a traction battery, comprising a ventilated plastic cover for covering an electrical connection strap, wherein a fan forces air to flow through the electrical connection strap of the battery to reduce the operating temperature of the battery. U.S. Pat. No. 3,834,945 discloses to use water to cool terminal posts and inter-cell electrical connection strap for a traction battery. No matter cooling is performed by air or water, improvement in heat exchange is not satisfactory due to the limited heat-exchanging area of the electrical connection strap. In addition, the design of a structure having a function of cooling the battery, e.g. the added water cooling system or a fan, etc., makes the entire structure of the battery more complex and the volume thereof large and heavy, which results in a complicated maintenance and installation process.

The above documents are incorporated herein in entirety by reference.

Therefore, the present invention is aimed to improve one or more defects in the prior art.

### SUMMARY OF THE INVENTION

The objective of the present invention is to provide an energy storage system preventing self from overheating, having excellent heat dissipating effect to prevent excessively high working temperature during high rate charging and discharging so as to prolong life of the energy storage system.

The above objective is achieved by an energy storage system having the following features. The energy storage system, in particular a battery system, and more particularly a valve-regulated type lead-acid battery system comprising at least one energy storage unit (cell) each having two terminal posts extending outwards from the interior thereof; when there are at least two energy storage units, electrical connection therebetween is achieved by electrical connection elements that bridge the terminal posts of different energy storage units, and at least one of the terminal posts and/or the electrical connection elements is in thermal connection with a heat transfer surface enlarging structure made of solid heat conductive materials. The heat transfer surface enlarging structure serves to increase an effective heat dissipating area of an element to be cooled, such as the terminal posts and/or the electrical connection elements, so cooling effect is enhanced to effectively prevent overheat of the energy storage system.

Preferably, the heat transfer surface enlarging structure includes a plurality of fins which may be arranged in a linear form, a radial form, a two or three-dimensional web-shaped form or a honeycomb-shaped form. The fins can be mounted fixedly or removably.

The heat transfer surface enlarging structure of fin type can be designed and mounted simply, maintained easily and produce particularly remarkable effect of improving heat dissipation.

In an embodiment of the invention, the heat transfer surface enlarging structure has a radial fan-shaped form. Preferably, the radial fan shaped heat transfer surface enlarging structure is in indirect thermal connection with the terminal posts and/or the electrical connection elements by means of a heat pipe or a heat pipe through which cooling medium flows. The heat pipe, in the case of limited installation space, transfers heat to a larger available space from the terminal posts and/or the electrical connection elements to increase effective heat dissipating area, and moreover the cooling medium circulating in the heat pipe can absorb part of the heat rapidly, so that the energy storage system may produce better cooling effect. Therefore, the heat transfer surface enlarging structure thus configured exhibits better mounting flexibility and makes it possible to increase effective heat dissipating area and cooling speed more considerably and to further improve heat dissipating and cooling effects.

In another embodiment of the invention, the solid heat conductive materials are metallic materials, such as copper, aluminum, iron and alloy thereof. Because of the higher thermal conductivity of the metallic materials, the heat transfer surface enlarging structure made of the metallic materials facilitates transfer of heat from the energy storage system to be cooled and thus facilitates reducing working temperature thereof.

According to one aspect of the invention, a method for preventing overheat of an energy storage system e.g. a battery system, in particular a valve-regulated type lead-acid battery system, comprising at least one energy storage unit each having two terminal posts extending outwards from the interior; when there are at least two energy storage units, electrical connection therebetween is achieved by electrical connection elements that bridge the terminal posts of different energy storage units, the method comprising thermally connecting a heat transfer surface enlarging structure made of solid heat conductive materials to at least one of the terminal posts and/or the electrical connection elements.

In the energy storage system for overheat prevention and the method for preventing overheat of the energy storage system according to the invention, because the terminal posts and/or the electrical connection elements of the energy storage system are in thermal connection with the heat transfer surface enlarging structure, the effective heat dissipating area of the terminal posts and/or the electrical connection elements is enlarged, and heat dissipation capacity thereof is enhanced, and further the working temperature of the energy storage system is reduced and the life thereof is prolonged.

### BRIEF DESCRIPTION OF THE DRAWINGS

The drawings constitute a part of the description show the exemplary embodiments of the invention and are intended to construe the principle of the invention with the description, in which,

FIG. 1 is a complete view of a prior art battery system;

FIG. 2 is a view of an electrical connection strap (electrical connection element) for connecting the terminal posts of a cell (i.e. an energy storage unit) of a prior art battery system;

FIGS. 3a-3e show different embodiments of the heat transfer surface enlarging structure of the invention in thermal connection with the electrical connection strap (electrical connection element);

FIG. 4 is a view of the heat transfer surface enlarging structure of the invention in thermal connection with the terminal posts;

FIG. 5 is a view of another exemplary heat transfer surface enlarging structure of the invention in thermal connection with the terminal posts;

FIG. 6 is a view of a radial shaped heat transfer surface enlarging structure of the invention which is in thermal connection with the terminal posts and/or the electrical connection elements by means of a heat pipe or a heat pipe through which cooling medium flows;

FIG. 7 shows comparison curves of heat dissipating capacity between an electrical connection strap in thermal connection with the heat transfer surface enlarging structure shown in FIG. 3a and a traditional electrical connection strap;

FIG. 8 shows comparison curves of heat dissipating capacity between an electrical connection strap in thermal connection with the heat transfer surface enlarging structure shown in FIG. 3b and a traditional electrical connection strap;

FIG. 9 shows comparison curves of heat dissipating capacity between an electrical connection strap in thermal connection, by means of a heat pipe, with the radial fan-shaped heat transfer surface enlarging structure shown in FIG. 6 and a traditional electrical connection strap;

FIG. 10 shows a comparison of real time heat dissipation between a negative terminal post of a battery having an electrical connection strap in thermal connection, by means of a heat pipe, with the radial fan-shaped heat transfer surface enlarging structure shown in FIG. 6 and a negative terminal post of a traditional battery;

FIG. 11 shows a comparison of real time heat dissipation between a positive terminal post of a battery having an electrical connection strap in thermal connection, by means of a heat pipe, with the radial fan-shaped heat transfer surface enlarging structure shown in FIG. 6 and a positive terminal post of a traditional battery.

### DETAILED DESCRIPTION OF THE EMBODIMENTS

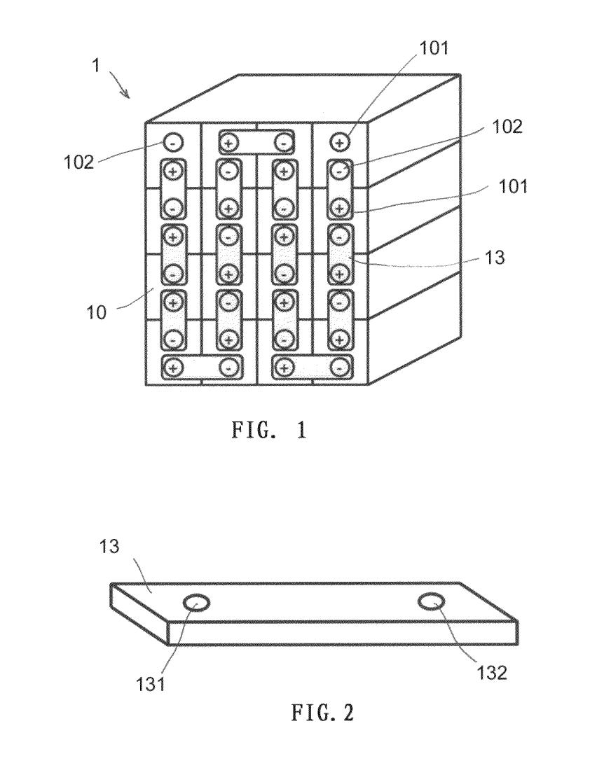

FIG. 1 shows an example of a prior art energy storage system (which is generally referred to as an electrical energy storage system). The energy storage system may be a battery system, a capacitor system or other electrical energy storage means. A battery system will be illustrated in detail below as an example. The battery system 1 includes a plurality of battery units (energy storage units) 10, having e.g. one or more cells (energy storage cells). The plurality of battery units 10 may be arranged in any array, and each has two terminal posts 101 (a positive terminal post) and 102 (a negative terminal post) leading from the interior thereof. An electrical connection between different battery units is achieved by means of an electrical connection strap (electrical connection element) 13 one end of which is connected to the positive terminal post 101 of one battery unit and the other end of which is connected to the negative terminal post 102 of another battery unit. The electrical connection strap 13 is made of a conductive material for conducting current among the battery units. The battery system 1 further includes terminal posts (posts), i.e. a positive post and a negative post, electrically connected to an external circuit.

A traditional electrical connection strap 13, as shown in FIG. 2, is a flat plate with a smooth surface and has connecting holes 131, 132 at both ends for connecting the terminal posts. In this embodiment, the electrical connection strap 13 is made of copper, with a dimension of 85 mm (length)×30 mm (width)×2 mm (thickness).

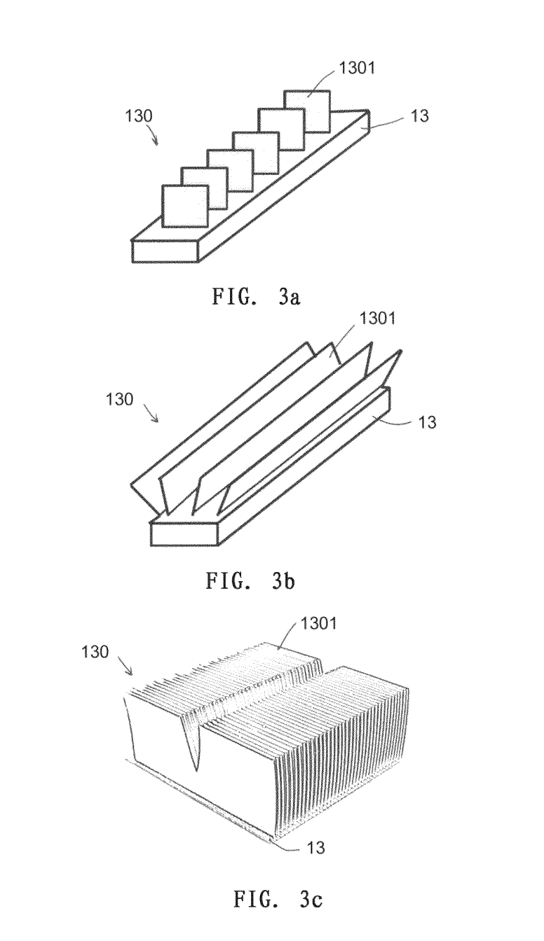

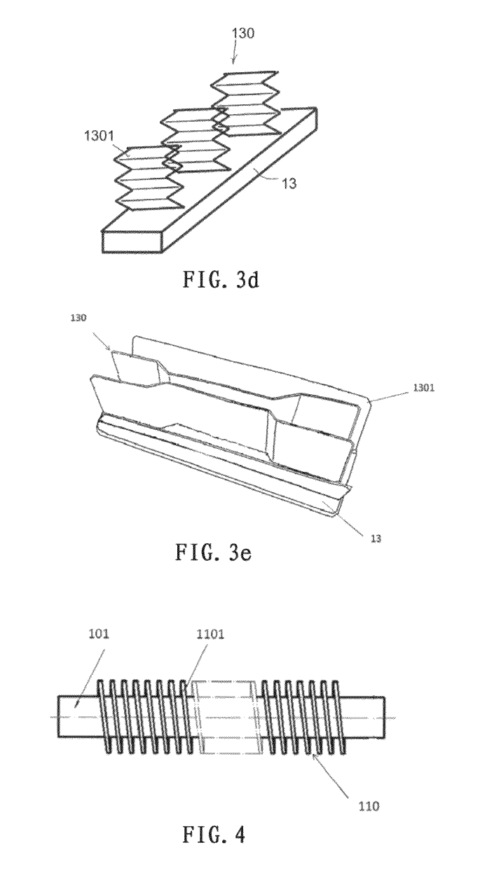

FIGS. 3a-3e show different embodiments of a heat transfer surface enlarging structure 130 of the invention in thermal connection with the electrical connection strap 13. The heat transfer surface enlarging structure 130 includes a plurality of fins 1301 in thermal connection with an exposed surface of the electrical connection strap 13. The plurality of fins in the embodiment illustrated in FIG. 3a are arranged linearly at certain intervals at one side of the electrical connection strap 13 along a lengthwise direction thereof. In the embodiment of FIG. 3b, the plurality of fins 1301 are arranged linearly at certain intervals at one side of the electrical connection strap 13 along a widthwise direction thereof. The embodiment shown in FIG. 3c is a variant made based on the embodiments of FIG. 3a, wherein the plurality of fins have a V-shaped cutout. Preferably, the V-shaped cutouts of the plurality of fins are substantially aligned to create a V-shaped airflow channel to facilitate airflow in the case of dense fins. The embodiment shown in FIG. 3d is another variant made on the basis of the embodiment of FIG. 3a, wherein each of the plurality of fins has folds curved along a direction perpendicular to the plane of the electrical connection strap. The embodiment shown in FIG. 3e is another variant made on the basis of the embodiment of FIG. 3b, wherein the fins 1301 extending along the lengthwise direction of the electrical connection strap 13 have a plurality of curved portions along its extending direction, so the distances between the fins are not regular, which is more favorable for generation of air turbulent flow and improvement of heat exchange.

Thanks to the fins 1301 in the present invention, heat exchanging surface area of the terminal posts and/or the electrical connection straps is increased so that the heat exchange between the terminal posts and/or the electrical connection straps 13 and the ambient environment is greatly enhanced, thus facilitating the decrease of temperature of the terminal posts and/or the electrical connection straps. Because the electrical connection strap and the terminal post are also in thermal connection, the terminal post, which primarily functions for electrical conduction though, also serves to conduct heat from the interior of a battery unit to the outside due to its distinctiveness of position and material. Therefore, decrease in temperature of the electrical connection strap is helpful in conducting heat from the interior of a battery unit to the outside to reduce working temperature thereof.

In addition to the means of increasing the effective heat exchange surface of the electrical connection strap 13, in order to accelerate the speed of conducting heat from the interior of a battery unit to the outside, a fin may be provided on part of the surface of the terminal post 101, 102 exposed externally to the battery. In a heat transfer surface enlarging structure 110 shown in FIG. 4, a plurality of fins 1101 are disposed linearly on part of the surface of the terminal post 101 exposed externally to the battery. Those skilled in the art may envisage that thermal connection between the plurality of fins 1101 and the terminal post 101 can be done by welding.

The technical term “thermal connection” herein refers to a direct or indirect thermal contact between the heat transfer surface enlarging structure e.g. a fin, and an electrical connection strap (electrical connection element) and/or a terminal post to create a heat flow channel for transferring heat flow.

The arrangements of the fins in the heat transfer surface enlarging structure shown in FIGS. 3a-3e and 4 are only exemplary. For those skilled in the art, the number and shape of the fins, the distance therebetween, the angle between the fins and the plane of the electrical connection strap or the peripheral surface of the terminal post, the material of the fins, the connection between the fins and the electrical connection strap or the terminal post and etc. can be selected freely as needed. For example, the plurality of fins can be arranged in a radial form, a two or three-dimensional web-shaped form, or a honeycomb-shaped form. Those skilled in the art may easily envisage that the fins can be connected to the electrical connection strap or the terminal post by conventional means, e.g. welding, hot compressing, mechanical fixing and so on. The fins may be integrally formed with the electrical connection strap or the terminal post.

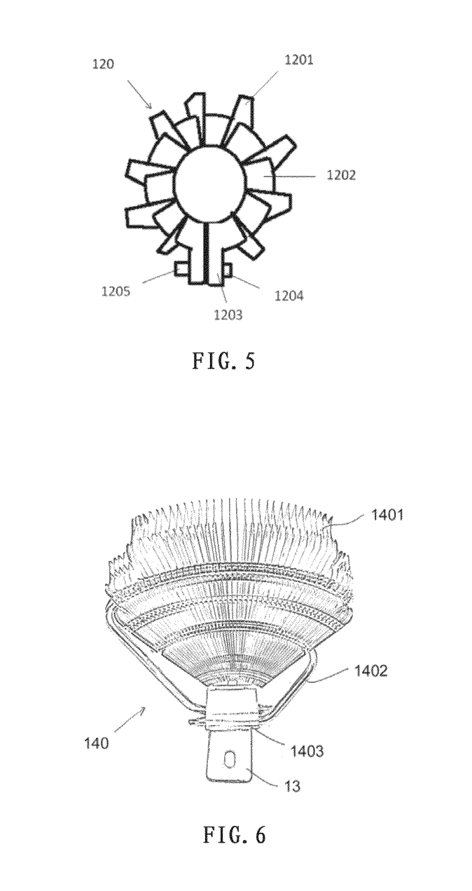

The fins may be fixed to the connection strap or the terminal post permanently or connected thereto removably. For instance, as shown in FIG. 5, a heat transfer surface enlarging structure 120 in the form of an opened fin ring has an annular body 1202 wrapping the terminal post or electrical connection strap, a rib portion 1201 extending radially outwards from the body, two tabs 1203 extending outwards from two ends of the annular body defining an opening of the fin ring, the two tabs being provided with aligned bolt holes. When the fin ring is sleeved onto the terminal post or the electrical connection strap, a bolt 1204 passes through the bolt holes and is screwed by a nut 1205 to secure the fin ring tightly to the terminal post or the electrical connection strap, so that the fin ring and the terminal post or the electrical connection strap are in thermal connection (thermal contact). This functions to increase available heat exchange area/effective heat exchange area of the terminal post or the electrical connection strap to improve cooling effect thereof.

In the event of limited installation space, a heat pipe or a heat pipe for circulating cooling medium therethrough may be taken into consideration to transfer heat from an electrical connection strap or a terminal post to a heat dissipation structure and/or circulating cooling medium arranged in available space to dissipate heat. In a heat dissipation structure 140 shown in FIG. 6, a radial fan-shaped heat transfer surface enlarging structure 1401 made of e.g. copper is welded to the electrical connection strap 13 by a copper plate 1403 and/or is fixed thereto by a bolt, two heat pipes 1402 being buried into the copper plate 1403 at one end and in thermal connection with a plurality of fins of the radial fan-shaped heat transfer surface enlarging structure 1401 in a lengthwise direction and extending in a curved manner about heat dissipating surfaces of the fins. With this configuration, heat is transferred from the electrical connection strap or the terminal post to the copper plate 1403 which then transfers the heat to a wall and/or end of the heat pipe in thermal connection therewith, the heat being transferred from the wall and/or end of the heat pipe to the plurality of fins of the radial fan-shaped heat transfer surface enlarging structure 1401, by means of which fins the heat is transferred to ambient air. Therefore, in the embodiment of FIG. 6, the radial fan-shaped heat transfer surface enlarging structure 1401 is arranged to increase effective heat dissipation area of the electrical connection strap to further enhance cooling effect thereof. Those skilled in the art can envisage that the heat pipe 1402 and/or the radial fan-shaped heat transfer surface enlarging structure 1401 may be made of any solid heat conductive material. In addition, the radial fan-shaped heat transfer surface enlarging structure may be arranged on the terminal post to increase effective heat dissipation area of the terminal post and to further enhance cooling effect thereof.

More preferably, the circulating cooling medium is allowed to flow through the heat pipe to absorb heat from the wall of the heat pipe. In this case, heat dissipation can be achieved simultaneously by two means, i.e. the plurality of fins of the radial fan-shaped heat transfer surface enlarging structure and the circulating cooling medium, so that the energy storage system is cooled rapidly and produces better cooling effect.

Preferably, the heat transfer surface enlarging structure, e.g. the fins or the radial fan-shaped heat transfer surface enlarging structure, may be made of a solid heat conductive material of excellent heat conductivity, .e.g. metallic materials. Preferably, the metallic materials may be selected from copper, aluminum, iron and alloy thereof.

The heat transfer surface enlarging structure in the present invention is not limited to the above fin structure or the radial fan-shaped heat transfer surface enlarging structure. For example, the heat transfer surface enlarging structure may also be a structure in a concave-convex configuration formed on the electrical connection strap or the terminal post, e.g. a groove, a pit or a bulge. The structure in a concave-convex configuration may be distributed over the exposed surface of the electrical connection strap or the terminal post in a certain manner or pattern, and also serves to increase available heat exchange area, and thus improves cooling or heat dissipation of the electrical connection strap or the terminal post.

Preferably, on an electrical connection strap or terminal post of a battery unit (an energy storage unit) at the center of the energy storage system, one or more heat transfer surface enlarging structures of the present invention are arranged, e.g. a fin structure or a radial fan-shaped heat transfer surface enlarging structure to enable substantially uniform working temperature of the battery units in different areas of the battery system so as to reduce heat accumulation of the system and decrease replacement or maintenance frequency of components of the battery system, thereby prolong life of the battery and its system.

In order to further enhance cooling effect of the electrical connection strap or the terminal post, the heat transfer surface enlarging structure according to the present invention may be used in combination with other conventional technical means of heat exchange enhancement. For example, a ventilation channel (hole) and a fan may be additionally provided on a transparent plastic cover of the battery for covering the electrical connection strap or the terminal post, to force air to flow rapidly through the heat transfer surface enlarging structure disposed on the electrical connection strap or the terminal post, thereby achieving the objective of improving heat transfer.

A flat electrical connection strap is taken as an example below in order to compare heat dissipation capacity (heat accumulation capacity) between a traditional electrical connection strap and an electrical connection strap in thermal connection with the heat transfer surface enlarging structure of the invention. In order to simulate temperature variation of different electrical connection straps that have absorbed equivalent amount of heat, first a fixed heat source is provided, and an equivalent amount of heat flow (the power of the heat source is 200 W) is allowed to flow through the traditional electrical connection strap and the electrical connection strap in thermal connection with the heat transfer surface enlarging structure of the invention; heat dissipation is performed at room temperature and surface areas of the electrical connection straps are measured in real time by means of thermoelectric couples.

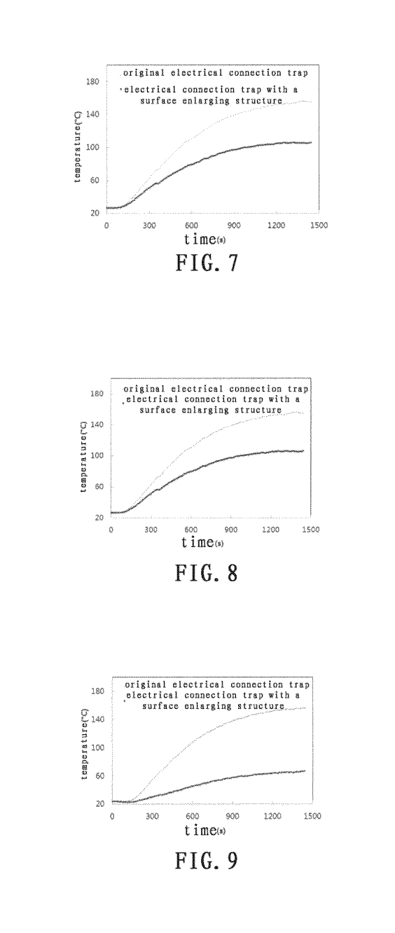

As shown in FIG. 7, the electrical connection strap in thermal connection with the heat transfer surface enlarging structure illustrated in FIG. 3a has a heat dissipation rate 33% faster than the traditional electrical connection strap, wherein the heat transfer surface enlarging structure has 7 fins made of copper, each fin having a dimension of 29×19 mm, an interval of 8 mm, and a surface area increase obtained thereby is 7714 mm².

As shown in FIG. 8, the electrical connection strap in thermal connection with the heat transfer surface enlarging structure illustrated in FIG. 3b has a heat dissipation rate 39% faster than the traditional electrical connection strap, wherein the heat transfer surface enlarging structure has 4 fins made of copper, each fin having a dimension of 83×19 mm, an interval of 10 mm, and a surface area increase obtained thereby is 12616 mm².

As shown in FIG. 9, the electrical connection strap in thermal connection with the radial fan-shaped heat transfer surface enlarging structure illustrated in FIG. 6 by means of a heat pipe has a heat dissipation rate 67% faster than the traditional electrical connection strap, wherein the radial fan-shaped heat transfer surface enlarging structure has an external dimension of 147 mm (length)×30 mm (width)×143 mm (height) (consisting of 70 copper fins), the heat pipe: φ6 mm×2 (one of which is 150 mm in length and the other is 300 mm in length), and a surface area increase obtained thereby is about 600600 mm².

It is found from these tests that the electrical connection strap in thermal connection with the heat transfer surface enlarging structure of the invention has a surface temperature significantly lower than the traditional electrical connection strap, which means that the former has greater heat dissipation capacity than the latter.

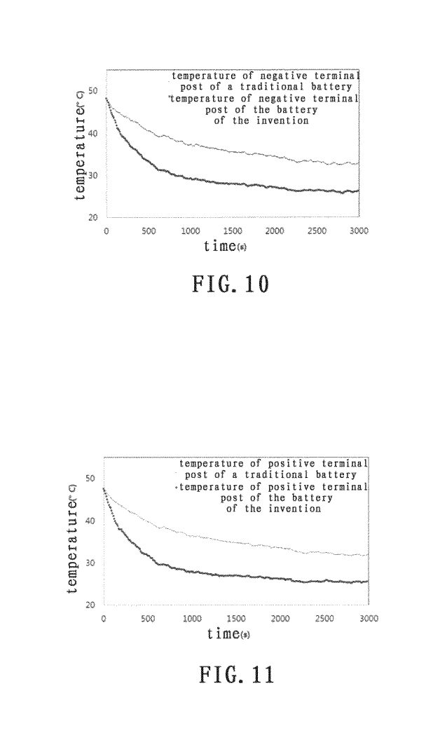

In addition, a test is performed to compare a battery having an electrical connection strap in thermal connection with the radial fan-shaped heat transfer surface enlarging structure illustrated in FIG. 6 by means of a heat pipe with a traditional battery. In order to simulate heat dissipation of different batteries that have absorbed equal amount of heat, first the batteries are heated at a certain temperature in a heating furnace until they reach a stable state and then are cooled naturally, and during this period of time, temperature at different locations of the batteries is measured by thermoelectric couples. It is found from the test that the temperature of the battery of the present invention (typically, the temperatures of the positive terminal post and the negative terminal post) decreases 50% faster than the traditional battery, dropping 10° C. in 50 minutes, as shown in FIG. 10 (temperature comparison of the negative terminal post) and FIG. 11 (temperature comparison of the positive terminal post).

It is necessary to note that because the resistance of the electrical connection strap (electrical connection element) or terminal post itself is extremely small and the heat transfer surface enlarging structure is usually made of a material of high electrical conductivity, change in resistance heat of the electrical connection strap and/or of the terminal post is negligible in the case of being in thermal connection with the heat transfer surface enlarging structure.

Although the battery system illustrated in the above embodiments has a plurality of battery units (energy storage units), those skilled in the art should envisage that the heat transfer surface enlarging structure of the invention can be applied to a battery system having one battery unit (energy storage unit).

The above depiction is only preferred embodiments of the present invention and is not taken as limiting or restricting this invention since various modifications and variations may be made to the energy storage system of the invention without departing from the scope of the present invention through the exercise of those skilled in the art. Other embodiments may be obtained on the basis of disclosure in the description. The description and embodiments shall be considered exemplary only and the true scope of the invention is defined by the annexed claims and equivalents thereof.

1. An energy storage system comprising:
at least one energy storage unit each having two terminal posts extending outwards from the interior thereof, wherein when there are at least two energy storage units, electrical connection therebetween is achieved by electrical connection elements that bridge the terminal posts of different energy storage units; and
a heat transfer surface enlarging structure made of solid heat conductive materials in thermal connection with at least one of the terminal posts or electrical connection elements.

2. The energy storage system according to claim 1, wherein the heat transfer surface enlarging structure comprises a plurality of fins.

3. The energy storage system according to claim 2, wherein the plurality of fins are arranged in a linear form, a radial form, a two or three-dimensional web-shaped form or a honeycomb-shaped form.

4. The energy storage system according to claim 2, wherein the fins are mounted fixedly or removably.

5. The energy storage system according to claim 3, wherein the heat transfer surface enlarging structure is a radial fan-shaped heat transfer surface enlarging structure, wherein the radial fan shaped heat transfer surface enlarging structure is in thermal connection with the at least one terminal post or electrical connection element by means of a heat pipe or a heat pipe through which cooling medium flows.

6. The energy storage system according to claim 1, characterized in that the solid heat conductive materials are metallic materials.

7. The energy storage system according to claim 6, wherein the metallic materials are selected from the group consisting of copper, aluminum, iron and alloy thereof.

8. The energy storage system according to claim 1, wherein the energy storage system is a battery system.

9. The energy storage system according to claim 8, wherein the energy storage system is a valve-regulated type lead-acid battery system.

10. A method for preventing overheat of an energy storage system comprising at least one energy storage unit each having two terminal posts extending outwards from the interior thereof, wherein when there are at least two energy storage units, electrical connection therebetween is achieved by electrical connection elements that bridge the terminal posts of different energy storage units, the method comprising thermally connecting at least one of the terminal posts or the electrical connection elements with a heat transfer surface enlarging structure made of solid heat conductive materials.

11. The method according to claim 10, wherein the heat transfer surface enlarging structure comprises a plurality of fins.

12. The method according to claim 11, wherein the plurality of fins are arranged in a linear form, a radial form, a two or three-dimensional web-shaped form or a honeycomb-shaped form.

13. The method according to claim 11, wherein the fins are mounted fixedly or removably.

14. The method according to claim 12, wherein the heat transfer surface enlarging structure is a radial fan-shaped heat transfer surface enlarging structure, wherein the radial fan shaped heat transfer surface enlarging structure is in thermal connection with the at least one terminal post or electrical connection element by means of a heat pipe or a heat pipe through which cooling medium flows.

15. The method according to claim 10, wherein the solid heat conductive materials are metallic materials.

16. The method according to claim 15, wherein the metallic materials are selected from the group consisting of copper, aluminum, iron and alloy thereof.

17. The method according to claim 10, wherein the energy storage system is a battery system.

18. The method according to claim 17, wherein the energy storage system is a valve-regulated type lead-acid battery system.
